(19) United States
(12) Patent Application Publication
(10) Pub. No.: US 2025/0052928 A1
(43) Pub. Date: Feb. 13, 2025

(54) IMPROVED ADHESION LAYER IN FLEXIBLE COVERLENS

(71) Applicant: Applied Materials, Inc., Santa Clara, CA (US)

(72) Inventors: Helinda Nominada, San Jose, CA (US); Harvey You, San Jose, CA (US); Han Nguyen, San Jose, CA (US); Tae Kyung Won, San Jose, CA (US); Seong Ho Yoo, San Ramon, CA (US); Soo Young Choi, Fremont, CA (US)

(73) Assignee: Applied Materials, Inc., Santa Clara, CA (US)

(21) Appl. No.: 18/719,540

(22) PCT Filed: Dec. 20, 2021
(86) PCT No.: PCT/US2021/064373

§ 371 Date: Jun. 13, 2024

(51) Int. Cl. G02B 1/14

(52) U.S. Cl. CPC G02B 1/14

(57) ABSTRACT

Exemplary flexible coverlenses and the methods of making them are described. The methods may include exposing a surface of a substrate layer to a surface treatment plasma to form a treated surface of the substrate layer. A silicon-containing adhesion layer may be deposited on the treated surface of the substrate layer. A silane-containing adhesion promoter may be incorporated on the silicon-containing adhesion layer. The method may also include forming a hardcoat layer on the silicon-containing adhesion layer, where the silane-containing adhesion promoter is bonded to both the hardcoat layer and the silicon-containing adhesion layer. The exemplary flexible coverlenses made by the present methods are less susceptable to folding fatigue along a bending or folding axis of the coverlens.

### TECHNICAL FIELD

The present technology relates to flexible display coverlenses having an improved adhesion layer. More specifically, the present technology relates to a flexible silicon-containing adhesion layer that bonds a substrate to a hardcoat layer in the coverlens.

### BACKGROUND

Displays for electronic devices are made possible by processes which produce intricately patterned material layers on substrate surfaces. Producing patterned material on a substrate requires controlled methods for deposition and removal of materials. However, with new device designs, producing high quality layers of material that meet device requirements is challenging.

Thus, there is a need for improved systems and methods that can be used to produce high quality devices and structures for electronic displays. These and other needs are addressed by the present technology.

### SUMMARY

Embodiments of the present technology include flexible coverlens processing methods. The methods may include exposing a surface of a substrate layer to a surface treatment plasma to form a treated surface of the substrate layer. A silicon-containing adhesion layer may be deposited over the treated surface of the substrate layer. A silane-containing adhesion promoter may be incorporated over the silicon-containing adhesion layer. The method may also include forming a hardcoat layer over the silicon-containing adhesion layer, where the silane-containing adhesion promoter contributes to the bonding between the hardcoat layer and the silicon-containing adhesion layer.

In additional embodiments, the surface treatment plasma may include oxygen and argon. In further embodiments, the treated surface of the substrate layer is not exposed to air before the depositing of the silicon-containing adhesion layer on the treated surface. In still further embodiments, the adhesion layer is deposited on the treated surface of the substrate layer with plasma-enhanced chemical vapor deposition. In yet additional embodiments, the silane-containing adhesion promoter includes a liquid that is sprayed or dip coated on the silicon-containing adhesion layer. In more embodiments, the silane-containing adhesion promoter further includes a methacrylate group. In yet more embodiments, the forming of the hardcoat layer over the silicon-containing adhesion layer includes coating a liquid hardcoat polymer on the silicon-containing adhesion layer, where the silane-containing adhesion promoter is incorporated on the silicon-containing adhesion layer. The liquid hardcoat polymer coated on the silicon-containing adhesion layer is then cured to form the hardcoat layer on the silicon-containing adhesion layer. In yet further embodiments, the curing of the liquid hardcoat polymer coated on the silicon-containing adhesion layer may include exposing the liquid hardcoat polymer to ultraviolet light.

Embodiments of the present technology also include flexible coverlenses that include a substrate layer and a silicon-containing adhesion layer. The adhesion layer is positioned over the substrate layer, and the adhesion layer further includes a silicon-containing adhesion promoter. The flexible coverlenses further include a hardcoat layer positioned over the silicon-containing adhesion layer. The hardcoat layer and the substrate layer are positioned on opposite sides of the silicon-containing adhesion layer, and the adhesion promoter contributes to the bonding of the hardcoat layer and the silicon-containing adhesion layer.

In additional embodiments, the substrate layer is a glass layer characterized by a thickness of less than or about 50 μm. In further embodiments, the silicon-containing adhesion layer includes a silicon oxide layer characterized by a thickness of less than or about 1 μm. In still further embodiments, the silicon-containing adhesion promoter includes an acryloxyalkyl silane compound. In yet additional embodiments, the hardcoat layer includes a urethane acrylate polymer characterized by a thickness of less than or about 50 μm. In more embodiments, the flexible coverlenses are free of an optically clear adhesive.

Embodiments of the present technology further include a flexible display device structure that includes a light source and a flexible coverlens. The flexible coverlens is positioned on the flexible display structure and may include a glass layer characterized by a thickness of less than or about 50 μm. The flexible coverlens also includes a silicon-containing adhesion layer positioned over the surface of the glass layer, and a hardcoat layer positioned over the silicon-containing adhesion layer. The hardcoat layer and the glass layer are positioned on opposite sides of the silicon-containing adhesion layer, and a silane-containing adhesion promoter contributes to the bonding of the hardcoat layer and the silicon-containing adhesion layer.

In additional embodiments, the silicon-containing adhesion layer includes a silicon oxide layer. In further embodiments, the adhesion promoter includes an acryloxyalkyl silane compound. In yet additional embodiments, the flexible coverlens is characterized by a thickness of less than or about 100 μm. In more embodiments, the flexible display structure further includes a touch panel. In yet more embodiments, the light source includes a light emitting diode, an organic light emitting diode, a liquid crystal display, or a quantum dot display.

The present technology has several benefits over conventional methods of bonding layers of material in a flexible coverlens with an optically-clear adhesive. For example, embodiments of the present technology bond layers of flexible coverlens with a silicon-containing adhesive layer and a silane-containing adhesion promoter that maintains those bonds through more bending cycles of the coverlens and other components of a foldable display. In embodiments, the silane-containing adhesion promoter includes at least one silane group that forms a strong bond with the silicon-containing adhesion layer and one or more additional bonding groups, such as an alkyl group, that forms a bond with organic polymers in a hardcoat layer.

### BRIEF DESCRIPTION OF THE DRAWINGS

A further understanding of the nature and advantages of the disclosed technology may be realized by reference to the remaining portions of the specification and the drawings.

FIG. 1 shows exemplary operations in a method of forming a flexible coverlens according to embodiments of the present technology.

FIG. 2A-2D show simplified cross-sectional views of a flexible coverlens being formed according to embodiments of the present technology.

FIG. 3 shows a simplified cross-sectional view of a flexible coverlens according to additional embodiments of the present technology.

FIG. 4 shows a simplified cross-sectional view of a flexible display device that includes a flexible coverlens according to embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

Electronic device displays typically include several layers of delicate and intricately patterned materials that work in concert to display high-resolution images. These layers can include colorizing layers to control the colors of the displayed images, polarizing layers to control the polarity of the light in the displayed images, and attenuating layers to control the intensity of the light in the displayed images, among other types of layers. A coverlens is normally placed over these layers to protect the device display from moisture, pressure, particle contamination, and scratching, among other environmental and use hazards. The coverlens typically includes a hard, inflexible surface, often made of high-strength glass, that makes the underlying layers of the display less susceptible to damage.

There is increasing demand for electronic devices that can reversibly bend or fold the display. Smartphones with foldable displays, for example, are becoming increasingly popular for reversibly increasing screen size during use while folding down into a more compact size when stored. Conventional display coverlenses made with inflexible sheets of glass lack the necessary level of foldability, so alternative materials and designs for flexible coverlenses are needed. These alternative materials have included sheets of flexible, translucent organic polymers that have the necessary folding characteristics. Unfortunately, many of these organic polymers are significantly softer than glass, and the surface of these organic polymer coverlenses are easily scratched. Many of the organic polymers also experience folding fatigue over time to create hazy and distorted lines in a displayed image along the folding axis.

Additional foldable coverlens designs include at least one layer of ultrathin glass (UTG) that is significantly more flexible than conventional coverlens glass. These UTG layers can fold like sheets made of flexible organic polymers with less folding fatigue. However, the UTG layer is still susceptible to scratching and fracturing, and a hardcoat layer of high-strength polymer may be attached to the UTG layer to reduce external stress on the coverlens. Conventional methods of attaching the hardcoat layer to the underlying UTG layer use a relatively thick layer of optically clear adhesive (OCA). Unfortunately, in many cases the OCA layer delaminates from the UTG layer along the axis of folding with the repeated opening and closing of the display device. The OCA layer also significantly increases the thickness of the flexible coverlens, making it more difficult to fully fold the display.

Embodiments of the present technology address these and other problems with flexible coverlenses having a hardcoat layer bonded to a glass substrate with an optically clear adhesive. In embodiments, a thin, silicon-containing adhesive layer is used to bond a hardcoat layer to a thin glass substrate in a flexible coverlens. In further embodiments, the silicon-containing adhesive layer includes a thin, inorganic, silicon-containing layer formed on the glass substrate in a dry deposition process such as chemical vapor deposition. The deposition process creates strong bonds between silicon-containing moieties in the adhesive layer and the glass substrate. In yet further embodiments, the silicon-containing adhesive layer formed on the glass substrate is exposed to at least one silane-containing adhesion promoter. In embodiments, the adhesion promoter contacts a surface of the silicon-containing adhesive layer that is opposite the surface in contact with the glass substrate. In further embodiments, the silane-containing adhesion promoter includes at least one silane moiety operable for bonding to silicon groups in the silicon-containing adhesive layer and at least one alkyl group operable for bonding to carbon groups in the hardcoat layer. In embodiments, each silane-containing adhesion promoter is bonded to both the silicon-containing adhesion layer and the hardcoat layer. In more embodiments, the bonds between the adhesion promoter and both the silicon-containing adhesive layer and the hardcoat layer are covalent bonds.

The strong, direct bonds that each silane-containing adhesion promoter forms with both the silicon-containing adhesion layer and the hardcoat layer are characterized by less susceptibility to delamination than bonding the adhesion layer and the hardcoat layer with an optically clear adhesive. The thick OCA layer positioned between the adhesion layer and hardcoat layer includes fewer compounds that form direct bonds with both layers. In most instances, the OCA polymer bonded to each of the layers are separated by the bulk polymer of the OCA layer. This can make the layers more susceptible to delaminating at an axis of folding after repeated openings and closings of the coverlens. In contrast the present silicon-containing adhesion layers that include the silane-containing adhesion promoters have more direct bonding of promoter compounds to both the silicon-containing adhesion layer and the hardcoat layer, which reduces the delamination of the layers after repeated folding of the coverlens.

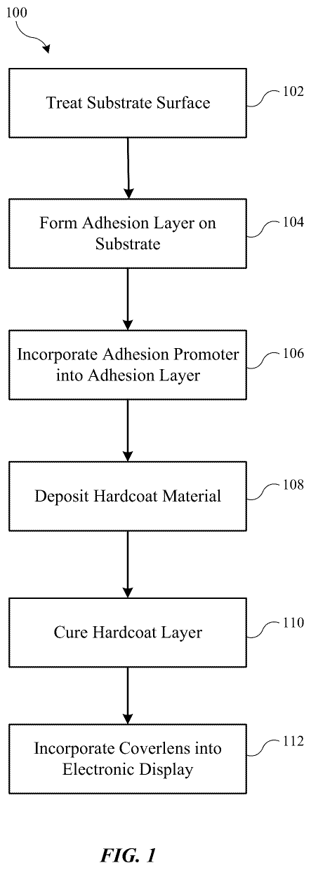

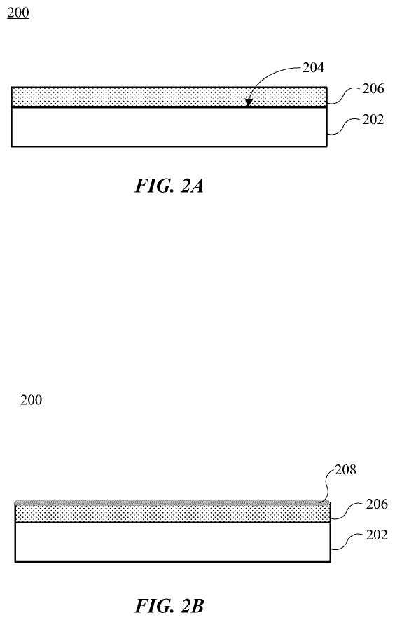

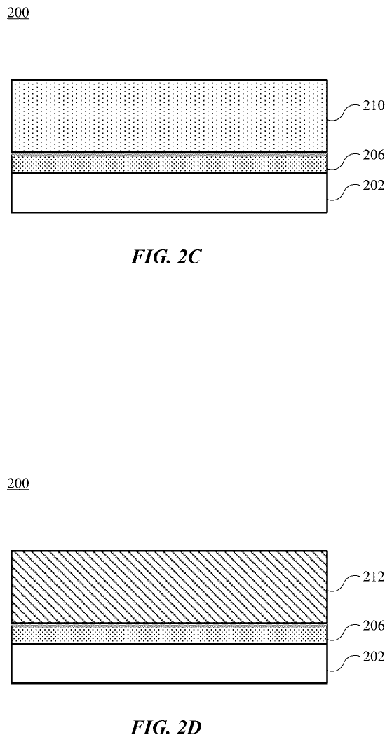

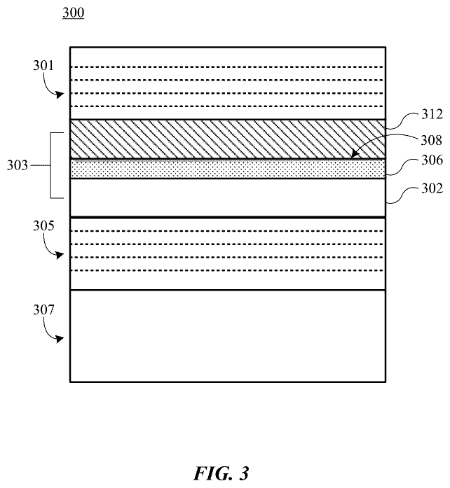

FIG. 1 shows exemplary operations in a method 100 of forming a flexible coverlens according to embodiments of the present technology. Method 100 may be performed in one or more processing chambers. Method 100 may or may not include one or more operations prior to the initiation of the method, including deposition, etching, polishing, cleaning, or any other operations that may be performed prior to the described operations. The method may include a number of optional operations, which may or may not be specifically associated with some embodiments of methods according to the present technology. Method 100 describes operations to form portions of a flexible coverlens 200 shown schematically in FIGS. 2A-2D, the illustrations of which will be described in conjunction with the operations of method 100. It is to be understood that FIGS. 2A-2D illustrate only partial schematic views with limited details, and in some embodiments a coverlens may contain any number of structural features having aspects as illustrated in the figures, as well as alternative structural features that may still benefit from one or more aspects of the present technology.

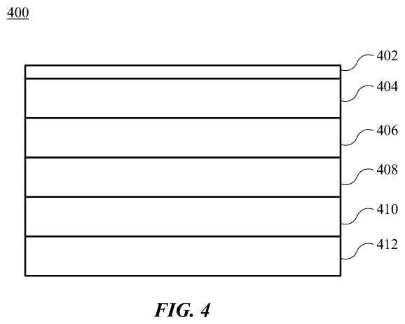

Method 100 may involve operations to develop a coverlens structure to a particular fabrication operation. Although in some embodiments method 100 may be performed on a base structure, in additional embodiments the method may be performed before and after other material formation. As illustrated in FIG. 3, embodiments of the coverlens may include a middle set of layers 303 with enhanced adhesion positioned between a first set of layers 301 formed over the hardcoat layer 312, and a second set of layers 305 on which the substrate layer 302 is formed. In still further embodiments, the coverlens structure that includes the first set of layer 301, middle set of layer 303, and second set of layer 305, may be positioned on a flexible display stack 307. Still further embodiments of the present technology are shown in FIG. 4, which shows the coverlens 402 incorporated in an electronic display device 400 after additional processing has been completed. For example, coverlens 402 may be incorporated into a device 400 that further includes a touch panel 410 and a light source 420, among other device features. It will be appreciated that device 400 may include components that have any number of conductive and/or dielectric materials including metals, including transition metals, post-transition metals, metalloids, oxides, nitrides, and carbides of any of these materials, as well as any other materials that may be incorporated within a device component.

Embodiments of method 100 may include preparing a substrate surface for the deposition of a silicon-containing adhesion layer at operation 102. In embodiments, operation 102 may include exposing surface 204 on substrate layer 202 shown in FIG. 2A to a treatment plasma. In additional embodiments, the substrate layer 202 may be an ultrathin glass layer that is exposed to a treatment plasma that removes oxidized material from the surface treated by the plasma. In further embodiments, the treatment plasma may be formed from a reducing gas such as hydrogen (H₂) and ammonia (NH₃), and a carrier gas such as helium (He), nitrogen (N₂) and argon (Ar). In yet further embodiments, the treatment plasma may be formed from gases that include hydrogen (H₂) and argon. In more embodiments, the treatment plasma may be characterized by a plasma temperature of greater than or about 300° C., greater than or about 325° C., greater than or about 350° C., greater than or about 375° C., greater than or about 400° C., greater than or about 425° C., greater than or about 450° C., greater than or about 475° C., greater than or about 500° C., or higher. In yet more embodiments, the substrate layer 202 may be exposed to the treatment plasma for greater than or about 1 minute, greater than or about 5 minutes, greater than or about 10 minutes, greater than or about 15 minutes, greater than or about 20 minutes, greater than or about 25 minutes, greater than or about 30 minutes, greater than or about 35 minutes, greater than or about 40 minutes, greater than or about 45 minutes, greater than or about 50 minutes, or longer. In still additional embodiments, the substrate layer 202 may be an ultrathin glass layer that is characterized by a thickness of less than or about 50 μm, less than or about 45 μm, less than or about 40 μm, less than or about 35 μm, less than or about 30 μm, less than or about 25 μm, less than or about 20 μm, less than or about 15 μm, less than or about 10 μm, less than or about 5 μm, or less.

Method 100 may further include forming a silicon-containing adhesion layer 206 on the treated substrate layer 202 at operation 104. In embodiments, the silicon-containing adhesion layer 206 may be formed by a dry deposition process. In additional embodiments, the dry deposition process may include physical vapor deposition (PVD), sputtering, chemical vapor deposition (CVD), plasma-enhanced chemical vapor deposition (PECVD), high-density-plasma chemical vapor deposition (HDP-CVD), atomic layer deposition (ALD), or plasma-enhanced atomic layer deposition (PE-ALD), among other dry deposition processes. In further embodiments, the dry deposition process may be a PECVD process that includes exposing the treated substrate layer 202 to a deposition plasma formed from a silicon-containing gas and an oxidizing gas. In embodiments, the silicon-containing gas may include silane, or a silicon-and-carbon containing deposition precursor such as tetra-ethyl-ortho-silicate (TEOS), among other silicon-containing plasma deposition gases. In further embodiments, the oxidizing gas may include oxygen (O₂) and/or nitrous oxide (N₂O), among other oxidizing gases. In yet further embodiments, the deposition plasma may further include a non-deposited carrier gas such as helium, nitrogen (N₂), and/or argon, among other carrier gases. In more embodiments, the PECVD process deposits a silicon-containing adhesion layer 206 that includes silicon oxide. In yet more embodiments, the as-deposited silicon oxide material may be characterized by a mole percentage of carbon that is less than or about 5 mol. %, less than or about 4 mol. %, less than or about 3 mol. %, less than or about 2 mol. %, less than or about 1 mol. %, or less. In still additional embodiments, the as-deposited silicon oxide material may be characterized by a mole percentage of nitrogen that is less than or about 25 mol. %, less than or about 15 mol. %, less than or about 10 mol. %, less than or about 5 mol. %, less than or about 2 mol. %, less than or about 2 mol. %, or less.

In embodiments, the silicon-containing adhesion layer 206 may be formed on the treated surface 204 without breaking vacuum between the treatment operation 102 and formation operation 104. In these embodiments, the treated surface 204 of the substrate layer 202 is not exposed to oxidizing gases and moisture before the silicon-containing adhesion layer 206 is formed on the surface. This can increase the strength of the bond between the silicon-containing adhesion layer 206 and the substrate layer 202. It can also reduce moisture and other contaminants in the as-deposited, silicon-containing adhesion layer 206.

As shown in FIG. 2A, the silicon-containing adhesion layer 206 is formed on the treated surface 204 of substrate layer 202. In embodiments, the silicon-containing adhesion layer 206 may be characterized by a thickness of less than or about 1000 nm, less than or about 900 nm, less than or about 800 nm, less than or about 700 nm, less than or about 600 nm, less than or about 500 nm, less than or about 400 nm, less than or about 300 nm, less than or about 200 nm, less than or about 100 nm, or less. In more embodiments, the silicon-containing adhesion layer 206 may include silicon oxide, silicon oxycarbide, silicon oxynitride, silicon nitride, silicon carbide, or silicon oxycarbide nitride, among other silicon-containing materials. In additional embodiments, the silicon-containing adhesion layer 206 may be characterized by an index of refraction that promotes the passage of light from a light source though the coverlens that includes the adhesion layer without noticeable image distortion. In more embodiments, the silicon-containing adhesion layer 206 may be characterized by an index of refraction less than or about 1.55, less than or about 1.52, less than or about 1.50, less than or about 1.48, less than or about 1.45, less than or about 1.43, less than or about 1.40, less than or about 1.38, less than or about 1.35, or less. In still more embodiments, the silicon-containing adhesion layer 206 may be characterized by a hardness that prevents the coverlens from being easily scratched or dented. In embodiments, the silicon-containing adhesion layer 206 may be characterized by a hardness of greater than or about 0.1 GPa, greater than or about 0.5 GPa, greater than or about 1 GPa, greater than or about 1.25 GPa, greater than or about 1.5 GPa, greater than or about 1.75 GPa, greater than or about 2 GPa, greater than or about 2.25 GPa, greater than or about 2.5 GPa, greater than or about 2.75 GPa, greater than or about 3 GPa, greater than or about 3.25 GPa, greater than or about 3.5 GPa, or more.

Method 200 may also include forming a silane-containing adhesion promoter layer 208 onto a surface of the silicon-containing adhesion layer 206, or another silicon-containing layer, at operation 106. As shown in FIG. 2B, the silane-containing adhesion promoter layer 208 may be formed on a surface of the silicon-containing adhesion layer 206 that faces opposite the surface in contact with treated surface 204 of the substrate layer 202. In embodiments, the silane-containing adhesion promoter layer 208 may be wet formed on the silicon-containing adhesion layer 206. In further embodiments, the silane-containing adhesion promoter layer 208 may be formed by contacting a solution or vapor that includes one or more silane-containing adhesion promoters on a surface of the silicon-containing adhesion layer 206. In still further embodiments, the solution or vapor of the silane-containing adhesion promoters may be deposited on the silicon-containing adhesion layer 206 by physical vapor deposition, chemical vapor deposition, vacuum deposition, spray coating, spin coating, or dip coating, among other application techniques. In further embodiments, the silane-containing adhesion promoter layer 208 may be formed on one or more intermediate layers between the silane-containing adhesion promoter layer and the silicon-containing adhesion layer 206. In embodiments, the one or more intermediate layers may include a silicon-containing material that can form bonds with the silane groups in the silane-containing adhesion promoter.

In embodiments, the solution of one or more silane-containing adhesion promoters may include an aqueous solution containing the adhesion promoters in an amount greater than or about 0.1 wt. %, greater than or about 0.2 wt. %, greater than or about 0.3 wt. %, greater than or about 0.4 wt. %, greater than or about 0.5 wt. %, or more. The concentration of the adhesion promoters in the aqueous solution may be relatively dilute to adjust the viscosity and surface tension of the solution in order to increase its wetting on the surface of the silicon-containing adhesion layer 206. In additional embodiments, the aqueous adhesion promoter solution may further include an acid to adjust the pH of the solution. In embodiments, the aqueous adhesion promoter solution may be characterized by a pH of less than or about 4.5, less than or about 4.4, less than or about 4.3, less than or about 4.2, less than or about 4.1, less than or about 4.0, less than or about 3.9, less than or about 3.8, less than or about 3.7, less than or about 3.6, less than or about 3.5, less than or about 3.4, less than or about 3.3, less than or about 3.2, less than or about 3.1, less than or about 3.0, or less. In more embodiments, the acid may be an organic acid such as acetic acid. Adjusting the pH of the aqueous adhesion promoter solution can increase the reactivity of the adhesion promoters with the silicon-containing adhesion layer 206.

In additional embodiments, the wet silane-containing adhesion promoter layer deposited on the silicon-containing adhesion layer 206 may be dried to form the silane-containing adhesion promoter layer 208. In embodiments, the drying process may include heating the as-deposited adhesion promotion layer in a drying environment characterized by a temperature of greater than or about 100° C., greater than or about 105° C., greater than or about 110° C., greater than or about 115° C., greater than or about 120° C., or more. In additional embodiments, the drying process may also include exposing the as-deposited adhesion promotion layer to a drying gas such as dry nitrogen (N₂) gas.

In embodiments, the silane-containing adhesion promoter may be a compound that includes at least one silane moiety that bonds to the silicon atoms in the silicon-containing adhesion layer 206, and at least one other moiety that bonds to the cured hardcoat layer 212 subsequently formed on the silicon-containing adhesion layer. In further embodiments, the at least one silane moiety may include an alkyl silane group or an alkoxy silane group, among other types of silane groups. In additional embodiments, the at least one silane moiety may include a silicon (Si) atom bonded to one, two, or three alkoxy groups such as methoxy groups, ethoxy groups, acetoxy groups, and combinations of alkyoxy groups. In further embodiments, the at least one silane moiety may be represented by the formula —Si(OR)₃, where R represents an alkyl group having one to four carbon atoms. In additional embodiments, the at least one other moiety that bonds to the hardcoat layer may include one or more of an amine group, an aldehyde group, a ketone group, a carboxylic acid group, a halogen group, or an alkene group, among other types of groups that are reactive with the hardcoat layer. In still additional embodiments, the silane-containing adhesion promoter may have the formula (RO)₃Si—Y—X, where each R independently represents an alkyl group having one to four carbon atoms, Y represents an linking group, and X represents at least one moiety that is operable to bond to the hardcoat layer. In yet more embodiments, the Y group may include an alkyl group or an alkoxy group, and the at least one X group may be, independently, an amine group, an aldehyde group, a ketone group, a carboxylic acid group, a halogen group, or an alkene group. In yet additional embodiments, the silane-containing adhesion promoter may be 3-aminopropyltriethoxysilane, or methacryloxypropyltrimethoxysilane, among other silane-containing adhesion promoters.

In embodiments, the silane-containing adhesion promoter may be selected to bond more easily to the silicon-containing adhesion layer 206 than a substrate layer 202 made from ultrathin glass. In further embodiments, the treated surface 204 of the substrate layer 202 may have fewer bonding sites for the silane moieties on the adhesion promoters than the silicon-containing adhesion layer 206. In these embodiments, the silicon-containing adhesion layer 206 increases the bond strength of the silane-containing adhesion promoter that bonds the silicon-containing adhesion layer to the hardcoat layer. The increased bond strength makes the layers less susceptible to delaminating along an axis of folding in the coverlens. In further embodiments, the silane-containing adhesion promoter may be covalent bonded to one or both of the silicon-containing adhesion layer 206 and the cured hardcoat layer 212. In still further embodiments, the silane-containing adhesion promoter layer 208 may be characterized by a thickness the length of the silane-containing adhesion promoters that make up the layer.

Method 200 may still further include depositing a hardcoat material 210 on the silicon-containing adhesion layer 206 that includes the silane-containing adhesion promoter layer 208 at operation 108. As shown in FIG. 2C, the hardcoat material 210 may be formed on a surface of the silicon-containing adhesion layer 206 in which the silane-containing adhesion promoter layer 208 has been formed. In embodiments, the hardcoat material may be characterized as a liquid or gel that is wet formed on the silicon-containing adhesion layer 206 and the silane-containing adhesion promoter layer 208. In further embodiments, the hardcoat material 210 may be deposited by a wet deposition technique such as, spray coating, spin coating, or dip coating, among other wet deposition techniques.

In additional embodiments, the hardcoat material 210 may include one or more acrylates, one or more solgels, one or more siloxanes, one or more copolymers thereof, one or more elastomers thereof, or any combination thereof. In further embodiments, the wet hardcoat material 210 includes an acrylate which can be or include a radiation curable acrylate, aliphatic urethane acrylate, a copolymer thereof, an elastomer thereof, or any combination thereof. In still further embodiments, the wet hardcoat material 210 includes a thermally-cured acrylate and/or a UV-cured acrylate. In more embodiments, the wet hardcoat material 210 includes one or more urethane-acrylates. In still more embodiments, the wet hardcoat material 210 includes one or more urethane-acrylates having the formula:

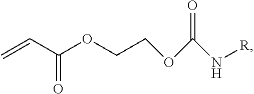

where R may be hydrogen or an alkyl group with 1 to 5 carbon atoms.

In more embodiments, the wet hardcoat material 210 may also optionally include one or more kinds of inorganic nanoparticles or other particulates displaced or otherwise disposed within the matrix of the hardcoat material. In further embodiments, the inorganic nanoparticles may include include one or more of silica, alumina, titanium oxide, zirconium oxide, and hafnium oxide. In still further embodiments, the inorganic nanoparticles can be nanoparticles may be characterized by an average particle size of less than or about 500 nm, less than or about 250 nm, less than or about 100 nm, less than or about 90 nm, less than or about 80 nm, less than or about 70 nm, less than or about 60 nm, less than or about 50 nm, or less. In yet additional embodiments, the weight percentage of the inorganic nanoparicles in the hardcoat material 210 may be less than or about 75 wt. %, less than or about 60 wt. %, less than or about 50 wt. %, less than or about 40 wt. %, less than or about 30 wt. %, less than or about 20 wt %, less than or about 10 wt. %, less than or about 5 wt. %, or less.

In additional embodiments, one or more layers of intermediate material may be positioned between the silane-containing adhesion promoter layer 208 and the wet hardcoat material 210. In embodiments, these layers of intermediate material may include compounds that facilitate the bonding of the hardcoat material 210 to the silane-containing adhesion promoter layer 208. In further embodiments, these materials may include one or more compounds with chemical groups that form covalent bonds with the silane-containing adhesion promoters, and one or more additional compounds that form covalent bonds with the wet hardcoat material 210.

The method 200 may still also include curing the as-deposited hardcoat material 210 into a cured hardcoat layer 212 at operation 110. As shown in FIG. 2D, the cured hardcoat layer 212 may be positioned on the surface of the silicon-containing adhesion layer 206 that includes the silane-containing adhesion promoter layer 208. In further embodiments, the silane-containing adhesion promoters may be covalently bonded to the cured hardcoat layer 212 and the silicon-containing adhesion layer 206 to form a strongly bonded group of adjacent layers in the coverlens. In additional embodiments, the curing operation 110 may include thermal curing and ultraviolet light curing, among other curing techniques. In still further embodiments, the as-deposited hardcoat material 210 may be dried before or as part of the curing operation 110. In embodiments, the drying process may include heating the as-deposited hardcoat material 210 in a dry environment. In still further embodiments, the drying process may be conducted in the same system or chamber as the drying process for the as-deposited silane-containing adhesion promoter layer 208.

In embodiments, the curing operation 110 may include exposing the wet or dried hardcoat material 210 to ultraviolet light. In additional embodiments, the ultraviolet light may be characterized by a peak light wavelength of less than or about 400 nm, less than or about 390 nm, less than or about 380 nm, less than or about 370 nm, less than or about 360 nm, less than or about 350 nm, less than or about 330 nm, less than or about 320 nm, less than or about 310 nm, less than or about 300 nm, or less. In further embodiments, the wet or dried hardcoat material 210 may be exposed to the ultraviolet light for a period of less than or about 60 minutes, less than or about 45 minutes, less than or about 30 minutes, less than or about 15 minutes, less than or about 10 minutes, less than or about 5 minutes, less than or about 2 minutes, less than or about 1 minute, or less. In more embodiments, the conclusion of the curing operation 110 may fix the thickness of the cured hardcoat layer at greater than or about 10 μm, greater than or about 20 μm, greater than or about 30 μm, greater than or about 40 μm, greater than or about 50 μm, or more.

As noted above, the cured hardcoat layer 212 forms a strong bond to the silane-containing adhesion promoters in the silane-containing adhesion promoter layer 208. In embodiments, the bond formed by the silane-containing adhesion promoters between the cured hardcoat layer 212 and the silicon-containing adhesion layer 206 may be characterized by a delamination strength that is greater than the delamination strength of a similar pair of layers bonded with an optically clear adhesive polymer. In additional embodiments, the delamination strength between the cured hardcoat layer 212 and the silicon-containing adhesion layer 206 may be characterized by a grade of 4B-5B according to the testing requirements of ASTM D3359.

In embodiments, the cured hardcoat layer 212 may be the layer of the coverlens that is exposed to stresses of device use. For the cured hardcoat layer 212 to withstand these stresses and maintain an optically clear, low-blemish viewing surface, the layer should include high hardness characteristics, and an appropriate refractive index. In embodiments where the cured hardcoat layer 212 is part of a flexible coverlens, the layer should also be characterized by good bending characteristics, low bending fatigue, and good light transmittance. In embodiments, the cured hardcoat layer 212 may be characterized by a pencil hardness of greater than or about 2H, greater than or about 3H, greater than or about 4H, greater than or about 5H, greater than or about 6H, greater than or about 7H, greater than or about 8H, greater than or about 9H, or more. In more embodiments, the cured hardcoat layer 212 may be characterized by a nano-indentation hardness of greater than or about 0.1 GPa, greater than or about 0.5 GPa, greater than or about 1 GPa, greater than or about 1.25 GPa, greater than or about 1.5 GPa, greater than or about 2 GPa, greater than or about 2.5 GPa, greater than or about 3 GPa, greater than or about 3.5 GPa, greater than or about 4 GPa, greater than or about 4.5 GPa, greater than or about 5 GPa, or more. In still more embodiments, the cured hardcoat layer 212 may be characterized by an index of refraction that is less than or about 1.55, less than or about 1.52, less than or about 1.50, less than or about 1.48, less than or about 1.45, less than or about 1.43, less than or about 1.40, less than or about 1.38, less than or about 1.35, or less.

In additional embodiments, the cured hardcoat layer 212 may be characterized by a bending inside radius of less than or about 20 mm, less than or about 15 mm, less than or about 10 mm, less than or about 7.5 mm, less than or about 5 mm, less than or about 2.5 mm, less than or about 1 mm, or less. In more embodiments, the cured hardcoat layer 212 may be characterized by a light transmittance in the visible portion of the spectrum (e.g., about 400 nm to about 700 nm in wavelength) that is greater than or about 90%, greater than or about 95%, greater than or about 96%, greater than or about 97%, greater than or about 98%, greater than or about 99%, or more. In still more embodiments, the flexible coverlens 200 that includes the cured hardcoat layer 212 may be characterized by a critical strain of less than or about 15%, less than or about 14%, less than or about 13%, less than or about 12%, less than or about 11%, less then or about 10%, less than or about 9%, less than or about 8%, less than or about 7%, less than or about 6%, less than or about 5%, or less.

FIG. 3 shows another embodiment of the present technology where the substrate layer 302, silicon-containing adhesion layer 306, silane-containing promoter 308, and hardcoat layer 312 are at least part of a middle set of layers 303 positioned between a first set of layers 301 facing a viewer and a second set of layers facing a flexible display stack 307. The first set of layers 301 positioned over the middle set of layers 303 may include one or more layers such as an additional adhesion promotion layer, an anti-reflective layer, an additional hardcoat layer, and an anti-fingerprint layer, among other layers. The second set of layers 305 positioned under the middle layers 303 may include one or more layers such as moisture barrier layer, an impact absorption layer, and a glass layer, among other layers. In embodiments, the coverlens includes the layers of the first set of layers 301, the middle set of layers 303, and the second set of layers 305. In further embodiments, the layers of the coverlens may be positioned over the flexible display stack 307.

In embodiments, the first set of layers 301 may include one or more adhesion promotion layers disposed on the hardcoat layer 312. In further embodiments, the adhesion promotion layer may include one or more of silicon oxide, silicon carbide, silicon oxycarbide, silicon nitride, silicon oxynitride, and silicon oxycarbide nitride. In additional embodiments, the adhesion promotion layer may be characterized by a gradient of carbon concentration across the thickness of the layer. In still further embodiments, the surface of the adhesion promotion layer closer to, or in contact with, the hardcoat layer 312 may be characterized by a higher carbon concentration than an opposite-facing surface of the adhesion promotion layer. In embodiments, the adhesion promotion layer may be characterized by a carbon concentration of greater than or about 1 wt. %, greater than or about 2.5 wt. %, greater than or about 5 wt. %, greater than or about 7.5 wt. %, greater than or about 10 wt. %, or more. In still more embodiments, the adhesion promotion layer may be characterized by a thickness of greater than or about 0.01 μm, greater than or about 0.05 μm, greater than or about 0.1 μm, greater than or about 0.25 μm, greater than or about 0.5 μm, greater than or about 0.75 μm, greater than or about 1 μm, greater than or about 2 μm, greater than or about 5 μm, greater than or about 10 μm, greater than or about 25 μm, greater than or about 50 μm, or more.

In still more embodiments, the first set of layers 301 may include an anti-reflective layer that reduces or prevents the reflection of light from the surface of the coverlens. In embodiments, the anti-reflective layer may include one or more silicon-containing materials such as silicon nitride, silicon oxynitride, silicon carbide nitride, and silicon oxycarbide nitride, among other silicon-containing materials. In further embodiments, the anti-reflective layer may be characterized by an index of refraction that is greater than or about 1.5, greater than or about 1.6, greater than or about 1.7, greater than or about 1.8, greater than or about 1.9, greater than or about 2.0, greater than or about 2.1, greater than or about 2.2, greater than or about 2.3, greater than or about 2.4, greater than or about 2.5, or more. In still additional embodiments, the anti-reflective layer may be characterized by an optical transmission in the visible range of greater than or about 85%, greater than or about 90%, greater than or about 95%, greater than or about 97.5%, greater than or about 99%, or more. In more embodiments, the anti-reflective layer may be characterized by a thickness of less than or about 1000 nm, less than or about 500 nm, less than or about 250 nm, less than or about 100 nm, less than or about 50 nm, less than or about 40 nm, less than or about 30 nm, less than or about 20 nm, less than or about 10 nm, less than or about 5 nm, less than or about 1 nm, or less.

In additional embodiments, the first set of layers 301 may further include one or more dry hardcoat layers. In embodiments, the dry hardcoat layer is characterized as dry because it is formed by one or more types of vapor deposition processes. Once deposited or otherwise formed, the dry hardcoat layer may be a solid layer which is completely dry or substantially dry. The dry hardcoat layer deposited, formed, or otherwise produced from a vapor deposition process which can be or include PVD, CVD, PE-CVD, HDP-CVD, ALD, PE-ALD, other vacuum or vapor deposition processes, or any combination thereof. In some examples, the dry hardcoat layer may be produced, deposited coated, or otherwise formed by a vacuum processing, atmospheric processing, solution processing, or other deposition or coating techniques, and then optionally treated or cured with a thermal and/or UV exposure. In one or more embodiments, the dry hardcoat layer may be formed, treated, and/or otherwise processed on a sheet-to-sheet processing system or a roll-to-roll processing system. For example, the dry hardcoat layer may be deposited, coated, or otherwise formed on an underlying surface, layer, or device by one or more sheet-to-sheet or roll-to-roll process techniques. In yet more embodiments, the dry hardcoat layer may be characterized by a porosity of less than or about 10 vol. %, less than or about 9 vol. %, less than or about 8 vol. %, less than or about 7 vol. %, less than or about 6 vol. %, less than or about 5 vol. %, less than or about 4 vol. %, less than or about 3 vol. %, less than or about 2 vol. %, less than or about 1 vol. %, or less. In sill more embodiments, the dry hardcoat layer may be characterized by a bending inside radius of about 1 mm to about 5 mm, a bending outside radius of less than or about 20 mm, less than or about 15 mm, less than or about 10 mm, less than or about 5 mm, or less.

In further embodiments, the first set of layers 301 may further include an anti-fingerprint layer as a top layer of the flexible coverlens. The anti-fingerprint layer, also known as an anti-smudge layer, may include one or more layers, films, or coatings and provides an overall upper surface for the flexible coverlens. The anti-fingerprint layer reduces or prohibits fingerprints, smudges, marring, and other contaminants on the outer and/or upper surfaces of the layer. The anti-fingerprint layer may include one or more materials which can be or include a fluorosilane, a perfluoropolyether-containing silane polymer, a chlorosilane, an oxasiline, a fluoroethylene, a perfluoropolyether, a nitrogen fluoride or nitrogen-fluorine containing compound, a polymer thereof, a dopant thereof, or any combination thereof.

In embodiments, the second set of layers 305 may include a moisture barrier layer. In further embodiments, the moisture barrier layer may be one or more films, coatings, or other layers which have intrinsic moisture or water barrier properties and are bendable, flexible, and/or foldable. In still further embodiments, the moisture barrier layer may include one or more one or more layers, such as a moisture and/or water vapor barrier layer, a high surface energy layer (e.g., hydrophilic properties), a planarization layer, an encapsulation layer, portions of layers thereof, or combinations thereof. In one or more embodiments, the moisture barrier layer may include one or more materials which can be or include silicon oxide, silicon nitride, silicon oxynitride, a dopant thereof, or any combination thereof. In more embodiments, the moisture barrier layer may include a single layer, while in yet more embodiments the moisture barrier layer may include multiple sublayers, such as 2, 3, 4, 5, 6, 7, 8, 9, or more sublayers. In embodiments, the moisture barrier layer may include a plurality of sublayers contained therein, such as greater than or about 2 sublayers, greater than or about 3 sublayers, greater than or about 4 sublayers, greater than or about 5 sublayers, or more. In yet additional embodiments, the moisture barrier layer may contain a film stack having three or more sublayers, such as a first sublayer, a second sublayer, and a third sublayer—where the second sublayer is disposed between the first and second sublayers. In embodiments, the film stack may be a SiN/SiO/SiN stack where the first sublayer can be or include silicon nitride, the second sublayer can be or include silicon oxide, and the third sublayer contains silicon nitride. In embodiments, the moisture barrier layer may be characterized by a water vapor transport rate of less than or about 10 g/m² day, less than or about 5 g/m² day, less than or about 1 g/m² day, less than or about 0.5 g/m² day, less than or about 0.1 g/m² day, less than or about 0.01 g/m² day, less than or about 0.1 g/m² day, less than or about 0.1 g/m² day, less than or about 0.01 g/m² day, less than or about 0.001 g/m² day, less than or about 0.0001 g/m² day, less than or about 0.00001 g/m² day, less than or about 0.000001 g/m² day, or less.

In additional embodiments, the second set of layers 305 may include an impact absorption layer. In further embodiments, the impact absorption layer may include one or more layers which are bendable, flexible, and/or foldable and used to absorb shock or impact. In more embodiments, the impact absorption layer may include one or more materials which can be or include ether urethane, ester urethane, aliphatic urethane, aliphatic polyurethane, aliphatic polyester urethane, polysulfide thermoset, poly amide, copolymers thereof, elastomers thereof, or any combination thereof. In further embodiments, the impact absorption layer may be characterized by a thickness of less than or about 250 μm, less than or about 200 μm, less than or about 150 μm, less than or about 100 μm, less than or about 50 μm, less than or about 25 μm, less than or about 10 μm, or less. In still more embodiments, the impact absorption layer may include an elastomer layer with a thickness of less than or about 100 μm, less than or about 75 μm, or less.

In yet additional embodiments, the second set of layers 305 may include a glass layer. In further embodiments, a surface of the glass layer may be in contact with the flexible display stack 307. In more embodiments, the glass layer may be an optically clear or transparent layer of glass characterized by a thickness of less than or about 200 μm, less than or about 150 inn, less than or about 100 μm, less than or about 90 μm, less than or about 80 μm, less than or about 70 μm, less than or about 60 μm, less than or about 50 μm, less than or about 40 μm, less than or about 30 m, less than or about 20 μm, less than or about 10 μm, or less.

The method 200 may further include incorporating the coverlens that includes the substrate layer 202, silicon-containing adhesion layer 206, and cured hardcoat layer 212, into an electronic display at operation 112. FIG. 4 shows a simplified cross-sectional schematic of an electronic display 400 that includes a coverlens 402 according embodiments of the present technology positioned on an assembly of additional elements in the electronic display. These additional elements may include a contrast enhancing and/or polarizer layer 404, a touch panel 406, a display layer 408 that includes a light source (not shown), a substrate layer 410 and a backing film 412. Together, these layers can make a bendable or foldable electronic display for an electronic device such as a smartphone, a monitor, a television, a tablet, a laptop computer, or a watch, among other kinds of electronic devices.

In embodiments, the contrast-enhancing and/or polarizer layer 404 may include a multi-function film layer containing a polarizer film. In further embodiments, the contrast-enhancing and/or polarizer layer 404 may be used to reduce unwanted reflections due to the reflective metal that makes up the electrode lines or metallic structures within the electronic display 400. In still further embodiments, the contrast-enhancing and/or polarizer layer 404 may include a quarter-wave retarder and a linear polarizer formed from flexible lens film with a thickness of less than or about 0.2 mm.

In additional embodiments, the touch panel 406 may include a touch sensor IC board and a touch sensor (not shown). In further embodiments, the touch sensor IC board is a flexible and metal based printed circuit board. In yet further embodiments, the display layer 408 may include one or more light emitting diode (LED) displays, one or more liquid crystal displays (LCDs), or other suitable display devices. In further embodiments, the display layer 408 may include an organic light emitting diode (OLED) display. In still further embodiments, the display layer 408 may include a quantum dot (OD) display. In additional embodiments, the display layer 408 may include a thin film encapsulation (TFE), an organic emitting layer, a driver IC board, and a thin film transistor (TFT).

In further embodiments, the substrate layer 410 may include a flexible plastic or polymeric substrate. In embodiments, the substrate layer 410 may be transparent and/or colorless and, in some examples, may be conductive. The substrate layer 410 may include one or more polyimide materials, polyester terephthalates, polyether ether ketones, transparent conductive polyesters, polycarbonates, polyaryletherketones, or any combination thereof. In further embodiments, the backing film 412 may include one or more heat sink layers and/or one or more protective barrier layers.

Embodiments of the present technology include methods of making flexible coverlenses that have reduced bending and folding fatigue due in part to a silicon-containing adhesion layer that makes the coverlens less susceptible to distortion and delamination. In embodiments, the silicon-containing adhesion layer includes silane-containing adhesion promoters that facilitate strong bonding between the adhesion layer and a hardcoat layer that protects the underlying components of the display from environmental stresses and normal wear-and-tear. In further embodiments, the silicon-containing adhesion layer that includes the silane-containing adhesion promoters replaces conventional optically-clear adhesives that are characterized by weaker bonding between the hardcoat layer and underlying layers of the flexible coverlens such as an ultrathin glass substrate layer.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology. Additionally, methods or processes may be described as sequential or in steps, but it is to be understood that the operations may be performed concurrently, or in different orders than listed.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “an adhesion promoter” includes a plurality of such promoters, and reference to “the layer” includes reference to one or more layers and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

1. A flexible coverlens processing method comprising:
exposing a surface of a substrate layer to a surface treatment plasma to form a treated surface of the substrate layer;
depositing a silicon-containing adhesion layer on the treated surface of the substrate layer;
incorporating a silane-containing adhesion promoter on the silicon-containing adhesion layer; and
forming a hardcoat layer over the silicon-containing adhesion layer, wherein the silane-containing adhesion promoter is bonded to both the hardcoat layer and the silicon-containing adhesion layer.

2. The flexible coverlens processing method of claim 1, wherein the surface treatment plasma comprises oxygen and argon.

3. The flexible coverlens processing method of claim 1, wherein the treated surface of the substrate layer is not exposed to air before the depositing of the silicon-containing adhesion layer on the treated surface.

4. The flexible coverlens processing method of claim 1, wherein the adhesion layer is deposited on the treated surface of the substrate layer with plasma-enhanced chemical vapor deposition.

5. The flexible coverlens processing method of claim 1, wherein the silane-containing adhesion promoter comprises a liquid that is sprayed or dip coated on the silicon-containing adhesion layer.

6. The flexible coverlens processing method of claim 1, wherein the silane-containing adhesion promoter further comprises a methacrylate group.

7. The flexible coverlens processing method of claim 1, wherein the forming of the hardcoat layer over the silicon-containing adhesion layer comprises:
coating a liquid hardcoat polymer on the silicon-containing adhesion layer, wherein the silane-containing adhesion promoter is incorporated on the silicon-containing adhesion layer; and
curing the liquid hardcoat polymer coated on the silicon-containing adhesion layer to form the hardcoat layer on the silicon-containing adhesion layer.

8. The flexible coverlens processing method of claim 7, wherein the curing of the liquid hardcoat polymer coated on the silicon-containing adhesion layer further comprises exposing the liquid hardcoat polymer to ultraviolet light.

9. A flexible coverlens comprising:
a substrate layer;
a silicon-containing adhesion layer in contact with a surface on the substrate layer, wherein the silicon-containing adhesion layer includes a silicon-containing adhesion promoter; and
a hardcoat layer over the silicon-containing adhesion layer, wherein the hardcoat layer and the substrate layer are positioned on opposite sides of the silicon-containing adhesion layer, and wherein the adhesion promoter is bonded to the hardcoat layer and the silicon-containing adhesion layer.

10. The flexible coverlens of claim 9, wherein the substrate layer comprises a glass layer characterized by a thickness of less than or about 50 μm.

11. The flexible coverlens of claim 9, wherein the silicon-containing adhesion layer comprises a silicon oxide layer characterized by a thickness of less than or about 1 μm.

12. The flexible coverlens of claim 9, wherein the silicon-containing adhesion promotor comprises an acryloxyalkyl silane compound.

13. The flexible coverlens of claim 9, wherein the hardcoat layer comprises a urethane acrylate polymer characterized by a thickness of less than or about 50 μm.

14. The flexible coverlens of claim 9, wherein the flexible coverlens is free of an optically clear adhesive.

15. A flexible display device comprising:
a flexible display structure comprising a light source; and
a flexible coverlens positioned on the flexible display structure, wherein the flexible coverlens comprises:
a glass layer characterized by a thickness of less than or about 50 μm;
a silicon-containing adhesion layer over a surface of the glass layer; and
a hardcoat layer over the silicon-containing adhesion layer, wherein the hardcoat layer and the glass layer are positioned on opposite sides of the silicon-containing adhesion layer, and wherein a silane-containing adhesion promoter contributes to bonding the hardcoat layer to the silicon-containing adhesion layer.

16. The flexible display device of claim 15, wherein silicon-containing adhesion layer comprises a silicon oxide layer.

17. The flexible display device of claim 15, wherein the silicon-containing adhesion promotor comprises an acryloxyalkyl silane compound.

18. The flexible display device of claim 15, wherein the flexible coverlens is characterized by a thickness of less than or about 100 μm.

19. The flexible display device of claim 15, wherein flexible display structure further comprises a touch panel.

20. The flexible display device of claim 15, wherein the light source comprises a light emitting diode, an organic light emitting diode, a liquid crystal display, or a quantum dot display.
